(19) United States
(12) Patent Application Publication
(10) Pub. No.: US 2016/0373904 A1
(43) Pub. Date: Dec. 22, 2016

(54) SYSTEM AND METHOD FOR CLASSIFICATION OF TEXT MESSAGE

(71) Applicant: HCL Technologies Limited, Noida (IN)

(72) Inventors: Daljeet SINGH, Noida (IN); Sourav DEY, Bangalore (IN)

(21) Appl. No.: 15/134,460

(22) Filed: Apr. 21, 2016

(30) Foreign Application Priority Data
Jun. 22, 2015 (IN) 1851/DEL/2015

(51) Int. Cl. H04W 4/14; H04M 19/04; H04L 12/24; H04W 24/08; H04L 12/801

(52) U.S. Cl. CPC H04W 4/14; H04W 24/08; H04L 47/35; H04L 41/0266; H04M 19/041

(57) ABSTRACT

The present disclosure relates to system(s) and method(s) for classification of text message. In one or more implementation, type of text message is monitored based on the one or activities performed on an input means of the transmitting device. Based on the type of activity performed the text message is embedded with tag which is unique to a type of message. The embedded text message is transmitted to a receiving device. The receiving device further processes the text message to identify the tag embedded within the text message. Once processed the text message is rendered on the receiving device with a different background or notification tone based on the tag to identify category of text message received.

### CROSS-REFERENCE TO RELATED APPLICATIONS AND PRIORITY

The present application claims benefit from Indian Complete Patent Application No. 1851/DEL/2015, filed on Jun. 22, 2015, the entirety of which is hereby incorporated by reference.

### TECHNICAL FIELD

The present disclosure generally relates to classification of message, and more particularly, relates to a system and method to classify and identify a text message as a forward, edited, or typed text message.

### BACKGROUND

Now-a-days users of mobile phone devices prefer to interact by means of short messages or text messages. The amount of text messages received by a user has increased due to availability of variety of mobile phone applications such as WhatsApp, Viber etc. and easy connectivity to internet. Due to its convenience of usage and low transmission cost text messages have become fast growing in telecommunication field.

A user may receive a multitude of text message that vary in an amount of importance to a recipient user. The user, for instance, may receive personal important text messages along with the forward message which may not be of immediate interest or importance to the user. Further, the user may also receive periodic messages from bank, promotions, offer for sale and so on. With this flood of text messages it is often difficult to identify the important message from that of a forwarded message.

However, at present no techniques are present that differentiates based on the type of message received. Consequently, the message recipient is forced to navigate though each message received to locate a text message of importance and immediate action. This increases the possibility of the user missing any important text message and further this could be time consuming and frustrating to the user.

### SUMMARY

This summary is provided to introduce aspects related to systems and methods for classification of text message and the aspects are further described below in the detailed description. This summary is not intended to limit the scope of the claimed subject matter.

In one embodiment, a system for displaying a text message based upon a category of the text message is disclosed. The system may include a transmitting device and a receiving device. The transmitting device includes a processor and a memory coupled to the processor. The processor may execute the instructions stored in the memory. In one embodiment, processor of the transmitting device may be configured to monitor one or more activities performed by a user of the transmitting device. The one or more activities may be performed on an input means of the transmitting device. The one or more activities may be associated with a text message. In one embodiment, the transmitting device may be configured to embed one or more tags in the text message based upon the one or more activities performed by the user. Each tag may indicate a category of the text message. Further, in one embodiment, processor of the transmitting device may be configured to transmit the text message to a receiving device. In one embodiment, the receiving device comprises a processor and a memory coupled to the processor. The processor may execute the instructions stored in the memory. The processor of the receiving device may be configured to process the text message in order to identify the category of the text message based upon the one or more tags embedded in the text message. Further, in one embodiment, processor of the receiving device may be configured to render the text message on the receiving device based upon the category of the text message.

In one embodiment, a method for displaying a text message based upon a category of the text message is disclosed. In one aspect, the method may include monitoring, by a transmitting device, one or more activities performed by a user of the transmitting device. The one or more activities may be performed on an input means of the transmitting device and the one or more activities may be associated with a text message. The method may include embedding, by the transmitting device, one or more tags in the text message based upon the one or more activities performed by the user. Each tag may indicate a category of the text message. Further, the method may include transmitting, by the transmitting device, the text message to a receiving device. In one aspect of the invention, the method includes processing, by the receiving device, the text message in order to identify the category of the text message based upon the one or more tags embedded in the text message. Further, the method includes rendering the text message on the receiving device based upon the category of the text message.

In one embodiment, a non-transitory computer readable medium embodying a program executable in a computing device for displaying a text message based upon a category of the text message is disclosed. The program may include a program code for monitoring one or more activities performed by a user of the transmitting device. The one or more activities may be performed on an input means of the transmitting device. The one or more activities are associated with a text message. The program may include a program code for embedding one or more tags in the text message based upon the one or more activities performed by the user. Each tag may indicate a category of the text message. Further, the program may include a program code for transmitting the text message to a receiving device. The program may further include a program code for processing the text message in order to identify the category of the text message based upon the one or more tags embedded in the text message. The program may further include a program code rendering the text message on the receiving device based upon the category of the text message.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for classification of text message, in accordance with an embodiment of the present subject matter.

FIG. 2 illustrates a block diagram for classification of text message, in accordance with an embodiment of the present subject matter.

### DETAILED DESCRIPTION

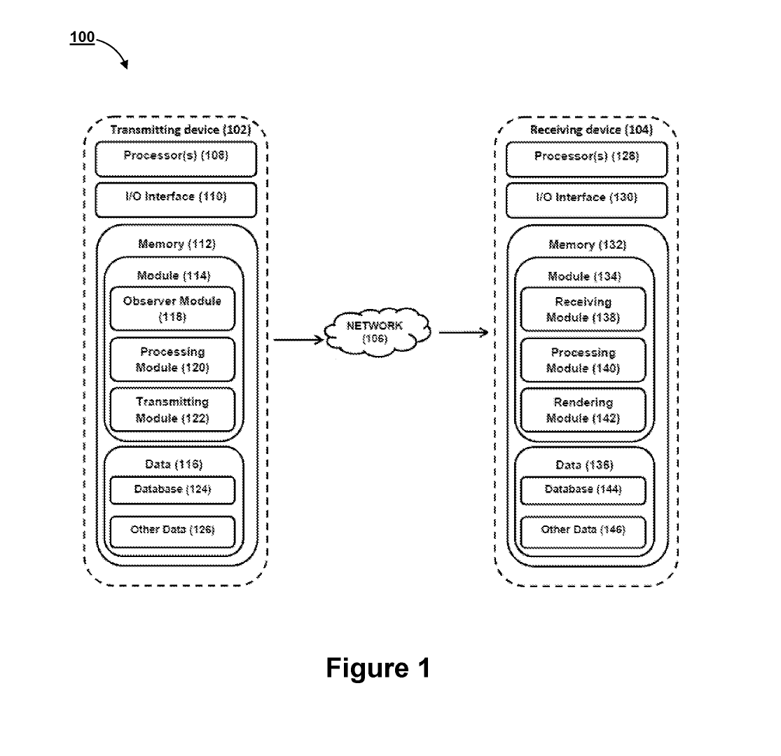

Referring now to FIG. 1, disclosed is a network implementation 100 in an example implementation that is operable to employ techniques described herein. The network implementation 100 includes a transmitting device 102 that is communicatively coupled to a receiving device 104 via a network 106. Although the present subject matter is explained considering that the transmitting device 102 and the receiving device 104 are hand-held device such as mobile phones, it may be understood that the transmitting device 102 and the receiving device 104 may be implemented using a wide variety of computing devices such as a laptop computer, a desktop computer, a notebook, a workstation, a mainframe computer, a server, a network server, and the like. The computing device may range from resource devices with substantial memory and processor resources to a resource device with limited memory and/or processing resources. In one implementation, the transmitting device 102 and the receiving device 104 may be implemented in a cloud-based environment. Additionally, although a single computing device is shown (e.g., a mobile phone for the transmitting device 102 and receiving device 104), the computing device may be representative of a plurality of different devices such as multiple servers utilized to perform different operations.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

The transmitting device 102 as illustrated in the FIG. 1 may further comprise a processor 108, an input/output (I/O) interface 110, and a memory 112 comprising plurality of modules, and data 120. The processor 108 may be implemented as one or more microprocessors, microcomputers, microcontrollers, digital signal processors, central processing units, state machines, logic circuitries, and/or any devices that manipulate signals based on operational instructions. Among other capabilities, the at least one processor 110 is configured to fetch and execute computer-readable instructions or modules stored in the memory 114.

Similarly, the receiving device 104 as illustrated in the FIG. 1 may further comprise a processor 128, an input/output (I/O) interface 130, and a memory 132 comprising plurality of modules 134, and data 136. The processor 108 may be implemented as one or more microprocessors, microcomputers, microcontrollers, digital signal processors, central processing units, state machines, logic circuitries, and/or any devices that manipulate signals based on operational instructions. Among other capabilities, the at least one processor 128 is configured to fetch and execute computer-readable instructions or modules stored in the memory 132.

The I/O interface 110, 130 of the transmitting device 102 and the receiving device 104 respectively may include a variety of software and hardware interfaces, for example, a web interface, a graphical user interface, and the like. The I/O interface 110, 130 may allow the transmitting device 102 and the receiving device 104 respectively to interact with a user directly. Further, the I/O interface 110, 130 may enable the transmitting device 102 and the receiving device 104 respectively to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 110, 130 may include one or more ports for connecting a number of devices to one another or to another server.

The memory 112, 132 of the transmitting device 102 and the receiving device 104 respectively may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 112, 132 may include modules 114, 132 which may perform particular tasks or implement particular abstract data types.

The modules 114, 134 of the transmitting device 102 and the receiving device 104 respectively include routines, programs, objects, components, data structures, etc., which perform particular tasks, functions or implement particular abstract data types. In one implementation, the modules 114 may include an observer module 118, a processing module 120, a transmitting module 122, and other modules. The other modules may include programs or coded instructions that supplement applications and functions of the transmitting device 102. In one implementation, the modules 134 may include a receiving module 138, a processing module 140, a rendering module 142, and other modules. The other modules may include programs or coded instructions that supplement applications and functions of the receiving device 104.

The data 116, 136 of the transmitting device 102 and the receiving device 104 respectively amongst other things, serves as a repository for storing data processed, received, and generated by one or more of the modules 114, 134. The data 116 may also include a database 124, and other data 126. The data 136 may also include a database 144, and other data 146. The database 124, 144 is configured to store the set of custom components and the set of metadata associated with each of the tag. In one embodiment, the other data 126, 146 may include data generated as a result of the execution of one or more modules in the other module.

According to embodiments of present disclosure, the system and method for classification of message are described in detail. In general, it is common for a user of a mobile device to receive several text message in-a-day of varying importance. The text message may be either typed message or forward message or edited messages. Depending on the importance and requirement of the message the user of the mobile device may choose to respond to the message. However, to identify a message of importance the user is required to read the other messages of no importance. Hence, it is the foremost requirement to monitor type of message being sent by the sender.

According to embodiments of present disclosure, the transmitting device may monitor the one or more activity performed by the user of the transmitting device. In one aspect of the disclosure the transmitting device is a mobile phone and the one or more activity corresponds carrying out of type operation or copy-paste/forward operation. The observer module 118, of the transmitting device 102, may capture the key presses on the keypad of the mobile device while entering in the text box to sent the text message. The observer module 118 shall observe for paste events in the text box and record the information. At the same time, if the observer module 118 recognizes that the text in the text box was typed or pasted and edited, the information shall be recorded in that manner.

Further, in one embodiment of the present disclosure, once the observer module observes and stores the activity performed by the user of the transmitting device the stored information is processed by the processing module 120 to embed tag based upon the one or more activities performed by the user. It is to be noted that unique tags are embed to each category of text message. In an exemplary embodiment a different tag is used for typed text and a different tag for copy pasted text. Further, in an exemplary embodiment, should a user uses that forward button of the keypad of the mobile phone then the message is tagged as ‘forwarded’. In one embodiment of the present disclosure tags are generated using markup language. The markup language may be a HTML markup text.

In another embodiment of the disclosure the markup language may be utilized to differentiate copy-pasted text to the manually typed text within the same text message. The processing module 120 shall be capable to identify with tags as a markup for copy pasted data. A example below illustrates the text with tags:

This portion was typed manually, <copy-pasted> this portion was copy pasted </copy-pasted> this portion was again typed manually <copy pasted> this portion was again copied from somewhere</copy-pasted>. This was again edited.

Further, the transmitting module 122 shall send the text message along with the embedded tag. It is to be noted that the flag may be sent as a meta-data along with the intended text message to the messenger server and further to the receiving device 104.

In one embodiment, the transmitting device 102 sends the embedded text message to the chat server or a service provider which further sends the embedded text message to the receiving device 104. It is to be noted that the chat server doesn't perform any function on the embedded text message and it send to the receiving device 104 as is.

In another embodiment of the disclosure, the processed message is received by the receiving module 138 of the receiving device 104. The received text message is now processed by the receiving device 104 by the processing module. The processing module identifies the category of the text message based upon the tag embedded in the text message. This category of message may be a typed message, edited message or a forward message.

Further, once identified the text message is rendered at the receiving end to display the received text. The receiving device 104, is capable to provide the receiver to render a different background color representation for differently tagged text message. The rendering may be based on whether the message is a typed message or a forwarded message. In one aspect of the disclosure, the message may be rendered to differentiate among the original and edited parts in text message. Further, in another aspect of the invention the text message may be rendered to provide different notification tone for differently tagged text message. It is to be noted that the receiving device 104 is capable to receive tagged text message and provides option to allow different notification tone for differently tagged text message.

### EXAMPLE 1

The user of the transmitting device may type a text message ‘Geeta will come from Bangalore on Friday’. Based on the key press, which relate to key press of the alphabets on the key pad, the observer module 118 of the transmitting device 102, may determine the text message as the ‘typed’ message and store the information for processing. Further, the processing module 120 may process the information stored by the observer module and embed tag corresponding to ‘typed’ message category. The tags may be generated using markup language. Further, the transmitting module 122 shall send the text message along with the embedded tag as a meta-data. The message may be received by the receiving module 138 of the receiving device 104. The received text message is processed by the processing module 140 of the receiving device. The processing module identifies the message tag as ‘typed’. Further, the rendering module 142 may render the ‘typed’ text message with assigned background colour or notification tone.

### EXAMPLE 2

The user of the transmitting device may partially type and partially copy-paste a text message. The text message is a neither a typed message category nor a forward message category. Thus, the user may copy-paste the message part ‘Geeta will come from Bangalore on Friday’ and type the message part ‘at 11:00 am’. Based on the key press, which relate to key press of the alphabets on the key pad and copy-paste function in the text box, the observer module 118 of the transmitting device 102, may determine the text message as the ‘copy-pasted’ message and store the information for processing. Further, the processing module 120 may process the information stored by the observer module and embed tag corresponding to ‘copy-pasted’ message data. The tags may be generated using markup language. Further, the transmitting module 122 may send the text message along with the embedded tag as a meta-data as ‘<copy-paste tag> Geeta will come from Bangalore on Friday <copy-paste tag> at 11:00 am’. The message may be received by the receiving module 138 of the receiving device 104. The received text message is processed by the processing module 140 of the receiving device 104. The processing module 140 identifies the message tag while the rendering module 142 renders the message to the user of the receiving device to identify the typed text portion and the copy-pasted text portion. The rendering may be by change in font colour or font type or font size for typed and copy-pasted text in the text message.

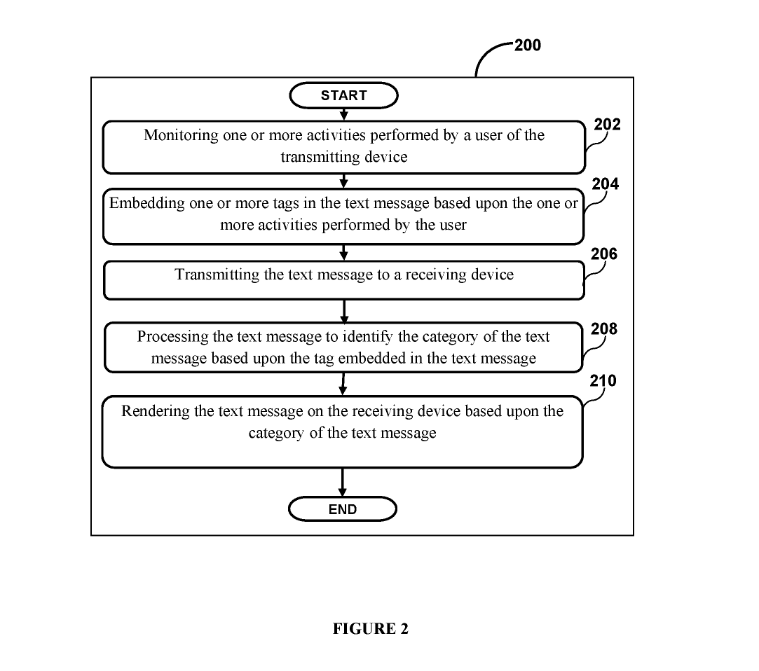

Referring now to FIG. 2, the method for classification of text message is shown, in accordance with an embodiment of the present disclosure. The method 200 may be described in the general context of computer executable instructions. Generally, computer executable instructions can include routines, programs, objects, components, data structures, procedures, modules, functions, etc., that perform particular functions or implement particular abstract data types. The method 200 may also be practiced in a distributed computing environment where functions are performed by remote processing devices that are linked through a communications network. In a distributed computing environment, computer executable instructions may be located in both local and remote computer storage media, including memory storage devices.

The order in which the method 200 is described is not intended to be construed as a limitation, and any number of the described method blocks can be combined in any order to implement the method 200 or alternate methods. Additionally, individual blocks may be deleted from the method 200 without departing from the spirit and scope of the disclosure described herein. Furthermore, the method can be implemented in any suitable hardware, software, firmware, or combination thereof. However, for ease of explanation, in the embodiments described below, the method 200 may be considered to be implemented in the above described system 202.

At block 202, one or more activities performed by a user of the transmitting device may be monitored.

At block 204, one or more tags in the text message based upon the one or more activities performed by the user may be embedded.

At block 206, text message may be transmitted to a receiving device.

At block 208, the text message is processed to identify the category of the text message based upon the tag embedded in the text message.

At block 210, the text message is rendered on the receiving device based upon the category of the text message.

Although implementations for method and system for smart home management using publish-subscription platform have been described in language specific to structural features and/or methods, it is to be understood that the appended claims are not necessarily limited to the specific features or methods described. Rather, the specific features and methods are disclosed as examples of implementations for smart home management using publish-subscription environment.

Exemplary embodiments discussed above may provide certain advantages. Though not required to practice aspects of the disclosure, these advantages may include those provided by the following features.

Some embodiments enable a system and a method for classification of text message for ease in identification.

Some embodiments enable a system and a method for classifying the message a forward to typed message.

Some embodiments enable a system and a method for rendering the text message different type of message with different notification tone or foreground or background colour.

Although implementations for methods and systems for classification of text message have been described, it is to be understood that the appended claims are not necessarily limited to the specific features or methods described. Rather, the specific features and methods are disclosed as examples of implementations for classification of text message.

We claim:

1. A method of displaying a text message based upon a category of the text message, the method comprising:
monitoring, by a transmitting device, one or more activities performed by a user of the transmitting device, wherein the one or more activities are performed on an input means of the transmitting device, and wherein the one or more activities are associated with a text message;
embedding, by the transmitting device, one or more tags in the text message based upon the one or more activities performed by the user, and wherein each tag indicates a category of the text message;
transmitting, by the transmitting device, the text message to a receiving device;
processing, by the receiving device, the text message in order to identify the category of the text message based upon the one or more tags embedded in the text message; and
rendering the text message on the receiving device based upon the category of the text message.

2. The method of claim 1, wherein the one or more activities comprises typing, copy-pasting, or forwarding function performed on the keypad of a transmitting device.

3. The method of claim 1, wherein the one or more tags are generated using markup language.

4. The method of claim 1, wherein the category of the text message is one of a typed text message, a forwarded text message, and/or an edited text message.

5. The method of claim 1, wherein the text message received by the receiving device is rendered to a preferred background color for a category of message.

6. The method of claim 1, wherein the text message received by the receiving device is rendered to a preferred notification tone for a category of message.

7. A system for displaying a text message based upon a category of the text message, wherein the system comprising a transmitting device and a receiving device, wherein the transmitting device further comprises a processor and a memory coupled to the processor, wherein the processor executes instructions stored in the memory for:
monitoring one or more activities performed by a user of the transmitting device, wherein the one or more activities are performed on an input means of the transmitting device, and wherein the one or more activities are associated with a text message;
embedding one or more tags in the text message based upon the one or more activities performed by the user, and wherein each tag indicates a category of the text message;
transmitting the text message to a receiving device;
the receiving device further comprises a processor and a memory coupled to the processor, wherein the processor executes instructions stored in the memory for:
processing the text message in order to identify the category of the text message based upon the one or more tags embedded in the text message; and
rendering the text message on the receiving device based upon the category of the text message.

8. A non-transitory computer program product, of a transmitting device, having embodied thereon a computer program for embedding a tag to a text message based upon a category of the text message, the computer program product comprising:
a program code for monitoring one or more activities performed by a user of the transmitting device, wherein the one or more activities are performed on an input means of the transmitting device, and wherein the one or more activities are associated with a text message;
a program code for embedding one or more tags in the text message based upon the one or more activities performed by the user, and wherein each tag indicates a category of the text message;
a program code for transmitting the text message to a receiving device;

9. A non-transitory computer program product, of a receiving device, having embodied thereon a computer program for displaying a text message based upon a category of the text message, the computer program product comprising:
a program code for processing the text message in order to identify the category of the text message based upon the one or more tags embedded in the text message; and
a program code for rendering the text message on the receiving device based upon the category of the text message.
